(19) United States
(12) Patent Application Publication
(10) Pub. No.: US 2013/0000484 A1
(43) Pub. Date: Jan. 3, 2013

(54) METHOD OF SEPARATING GAS MIXTURES

(76) Inventor: Paul Jason Williams, Richmond, TX (US)

(21) Appl. No.: 13/581,838

(22) PCT Filed: Mar. 3, 2011
(86) PCT No.: PCT/US11/27007

§ 371 Date: Aug. 30, 2012

Related U.S. Application Data
(60) Provisional application No. 61/310,503, filed on Mar. 4, 2010.

(51) Int. Cl. B01D 71/02; B01D 65/02; F26B 7/00; B01D 53/22

(52) U.S. Cl. 95/51; 95/45; 34/413

(57) ABSTRACT

A method of separating a first gas component from a feed gas mixture comprising the first gas component and a second gas component using a SAPO-34 molecular sieve membrane. Periodically removing unwanted components that are absorbed on the membrane may be accomplished by passing a regeneration gas stream through the membrane.

### FIELD OF THE INVENTION

This application relates to a method of separating a gas mixture into its components.

### BACKGROUND

The technology of gas separation is important in many fields, and is particularly important in the field of natural gas processing. In many natural gas fields in the world, the natural gas is contaminated with high concentrations of impurities, including carbon dioxide, hydrogen sulfide, carbonyl sulfide and heavier hydrocarbons. Current methods of gas production are typically limited to the economical production of natural gas that has less than 25-30% of these impurities.

Separation of gas mixtures using molecular sieve inorganic membranes can help address this problem and remove larger quantities of impurities economically. U.S. Pat. No. 7,316,727 describes a gas separation molecular sieve membrane that is on a porous support. A gas mixture is passed through the porous support and the gas separates into different components across the membrane. The patent describes a membrane that is made from SAPO-34 (silicoaluminophosphate) crystals as being useful for the separation of natural gas from the impurities typically found with natural gas. U.S. Pat. No. 7,316,727 is herein incorporated by reference in its entirety.

Improved SAPO-34 membranes are being developed and these membranes have been found to be very useful in separating the impurities from the natural gas. It has been found that there can be a decrease in the performance of the membranes when water or heavier hydrocarbons are present in the gas mixture. In addition, there may be a loss of molecular sieve crystallinity and porosity on aging during storage and handling after manufacture if water is present. Attempts have been made to make the membranes more resistant to water, but these methods do not address the problem of water in the gas mixture.

U.S. Pat. No. 6,916,965 describes a method of treating a metalloaluminophosphate molecular sieve with one or more nitrogen compounds, selected from the group consisting of amines, monocyclic heterocyclic compounds and organonitrile compounds. These membranes are used for the catalytic conversion of oxygenate feedstock to hydrocarbons. The nitrogen-containing compound chemisorbs and/or physisorbs with the molecular sieve and provides protection from water during storage and transport. Before the sieve can be used, however, it must be regenerated to remove the nitrogen-containing compounds. U.S. Pat. No. 6,916,965 is herein incorporated by reference in its entirety.

U.S. Pat. No. 7,495,142 teaches that a SAPO-34 molecular sieve will exhibit a shortened catalytic life for methanol to olefins catalysis when exposed to a moisture-containing environment. The patent describes treating the membrane with 45%-99.8% alcohol to protect it from water degradation. This method may be effective, but if this method is applied to SAPO-34 membranes used for gas separation, the alcohol must be removed before use otherwise it will block access to the nanoporosity in the SAPO-34 crystals thereby limiting the usefulness of the membrane. U.S. Pat. No. 7,495,142 is herein incorporated by reference in its entirety.

### SUMMARY OF THE INVENTION

One aspect of this invention provides a method of separating a first gas component from a feed gas mixture comprising the first gas component and a second gas component, which method comprises: a) providing a SAPO-34 molecular sieve membrane having a feed side with a feed inlet and a retentate outlet; and a permeate side with a permeate outlet, wherein the membrane is selectively permeable to the first gas component over the second gas component; b) introducing the feed gas mixture to the feed inlet; c) yielding a permeate stream from the permeate outlet and a retentate stream from the retentate outlet wherein the retentate stream is depleted of the first gas component and the permeate stream is rich in the first gas component; and d) periodically removing unwanted components that are absorbed on the membrane by passing a regeneration gas stream comprising a third gas component through the membrane by feeding the regeneration gas stream to the membrane, and then stopping the regeneration gas stream.

Another aspect of this invention provides a method of starting up a process for separating a first gas component from a feed gas mixture comprising the first gas component and a second gas component, which method comprises a) providing a SAPO-34 molecular sieve membrane having a feed side with a feed inlet and a retentate outlet; and a permeate side with a permeate outlet, wherein the membrane is selectively permeable to the first gas component over the second gas component; b) passing a startup gas stream comprising a third gas component through the membrane to remove unwanted components; c) stopping the flow of the startup gas stream; d) introducing the feed gas mixture to the feed inlet; e) yielding a permeate stream from the permeate outlet and a retentate stream from the retentate outlet wherein the retentate stream is depleted of the first gas component and the permeate stream is rich in the first gas component.

Another aspect of this invention provides a method of removing water from a SAPO-34 membrane comprising passing carbon dioxide through the membrane at a pressure in the range of from 4 to 80 bar and at a temperature in the range of from −40 to 300° C.

### BRIEF DESCRIPTION OF THE DRAWING

FIG. 1 depicts one embodiment of a typical molecular sieve membrane on a porous tubular support.

FIG. 2 depicts an embodiment of the method described herein.

### DETAILED DESCRIPTION OF THE INVENTION

One aspect of the present invention provides a method of separating gas mixtures using a SAPO-34 membrane that also solves the problem of removing unwanted components that are absorbed on the membrane. This method can result in the membrane being restored to 90+% of its original performance without having to remove or replace the membrane.

The supported gas separation molecular sieve membrane can be used in a wide variety of gas separation applications. For example, it may be used in the separation of low molecular weight alkanes from relatively higher molecular weight alkanes, or normal alkanes from isoalkanes, or low molecular weight hydrocarbons (e.g. methane, ethane, propylene, butane, ethylene, propylene, and butylenes) from inorganic or non-hydrocarbon compounds, including acidic contaminants.

The SAPO-34 membranes are made by forming a continuous layer of SAPO-34 crystals on a porous support. One skilled in the art can use any of the known methods or any method developed in the future to prepare a suitable SAPO-34 membrane that would be useful for separating gas mixtures. The SAPO-34 membrane typically consists of a 0.5 to 20 micron SAPO-34 zeolite layer on the surface of a porous metal or ceramic support. SAPO-34 crystals have an effective sieving diameter of approximately 3.8 angstroms. Due to the pore size and chemistry, the separation of low molecular weight hydrocarbons from impurities such as CO₂ and H₂S takes place via selective adsorption and molecular sieving.

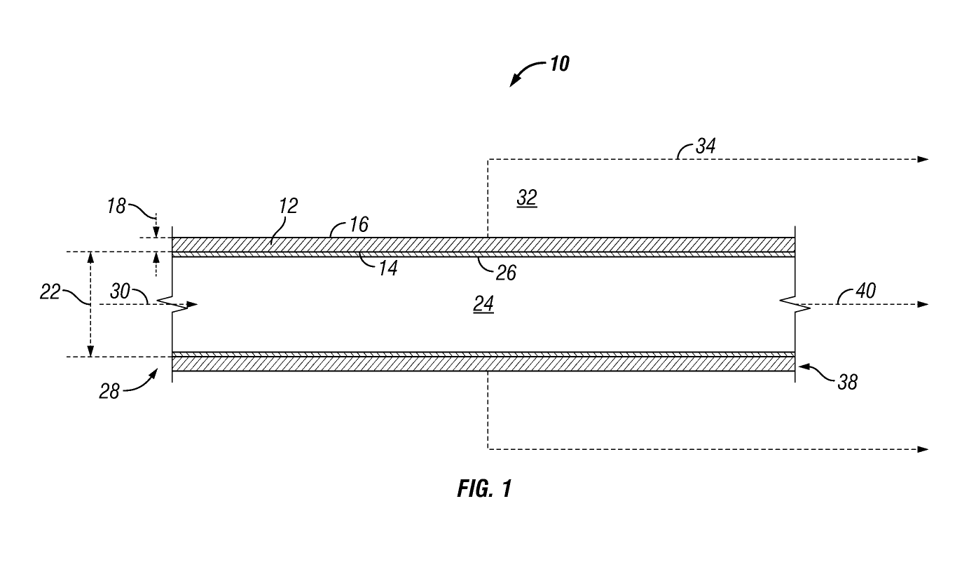

### FIG. 1:

The process will be further described in relation to FIG. 1. FIG. 1 depicts a single, circular tube, but it should be understood that the supported gas separation membrane 10 can be selected from any suitable geometry, including but not limited to polygonal supports, multichannel supports, monolithic supports, and hollow fiber supports. Also, the tubular supported gas separation membrane 10 may be manifolded together with a plurality of other such tubes to form an assembly (not shown) of tubes for use in gas separation.

The tubular supported gas separation membrane 10 depicted in FIG. 1 includes a tubular porous support 12 having an inside surface 14 and an outside surface 16 that together define a wall thickness 18. The inside surface 14 defines an inside diameter 22 and a tubular conduit 24 which provides a feed side of the tubular supported gas separation membrane 10 for receiving therein and passing therethrough a gas mixture.

It is noted that, in the situation when the geometry of the support structure is something other than tubular, for example, multichannel supports, monolithic supports or the like, the inside surface of the conduits of such structures relative to the outside dimensions does not take on the same significance as in the use of individual tubular support structures.

The surface areas of the inside surface 14 and the outside surface 16 can either or both be coated with a thin membrane layer of molecular sieve crystals. But, a preferred embodiment is shown in FIG. 1 with only the inside surface 14 coated with a thin, selectively permeable membrane layer 26 of molecular sieve crystals.

The tubular supported gas separation membrane 10 further has a feed inlet end 28 for receiving a gaseous mixture that comprises two or more gas components such as a first gas component and a second gas component that is introduced into the tubular conduit 24 by way of a line 30. The tubular conduit 24 in this instance serves as the feed side of the tubular supported gas separation membrane system 10.

The gaseous mixture introduced into conduit 24 may comprise two or more gas components selected from carbon dioxide; hydrocarbons, for example, methane, ethane, propane, butane, and heavier hydrocarbons which are defined as hydrocarbons having a carbon number greater than four; non-hydrocarbons, for example, hydrogen sulfide, carbonyl sulfide, and nitrogen; and other molecules that are gaseous under the conditions of use of the tubular supported gas separation membrane 10.

As the gaseous mixture passes through tubular conduit 24 a separation takes place whereby the first gas component, which is more permeable through the membrane layer 26 than the second gas component, preferentially passes through membrane layer 26 to permeate side 32 of the tubular supported gas separation membrane 10. A permeate stream is yielded and passes from the permeate side 32 by way of line 34. The permeate stream is richer in the first gas component than the feed and retentate streams.

The tubular supported gas separation membrane 10 also has a retentate outlet end 38 for passing a retentate stream depleted of the first gas component of the gaseous mixture from the tubular conduit 24. The retentate stream is yielded and passes from the feed side, i.e., tubular conduit 24, by way of line 40.

In an embodiment where the molecular sieve membrane is used to separate impurities from the hydrocarbons typically found in natural gas, the process is carried out at the following process conditions. The pressure on the feed side of the supported gas separation membrane can be in the range of from atmospheric upwardly to 2000 psi. But, more typically, the feed side pressure is in the range of from 5 psi to 1700 psi, and, most typically, from 10 to 1400 psi. The pressure drop across the gas separation membrane system can, typically, be in the range of from 5 psi to 1500 psi, and, most typically, from 10 to 1200 psi. The operating temperature on the feed side of the supported gas separation membrane can vary widely. The operating temperature can, thus, be in the range of from less than or about −40° C. to 300° C., more typically, from −10° C. to 150° C., and, most typically, from −5° C. to 100° C.

Because the supported gas separation membrane of the invention is selectively permeable to CO₂ over CH₄, the permeate stream from the supported membrane will be enriched in CO₂ in comparison to the feed stream, with a relatively low concentration of CH₄ while the retentate stream will be depleted in CO₂.

During the operation of this method, the membrane may absorb water and heavier hydrocarbons that are present in the gas mixture and this may result in a reduced performance of the membrane as shown by a reduced permeance of the first and sometimes all gas component(s) through the membrane. Eventually, the membrane may become plugged with these other materials and may no longer be effective as a gas separation membrane. It is desirable to incorporate a method of removing these unwanted components from the membrane to restore its performance to a level similar to that achieved when the membrane was initially placed into service.

After the membrane is manufactured, it must be shipped and installed before it is placed in service. During transport, storage, and/or installation the membrane may come into contact with water or other components that absorb on the surface. This would result in a membrane that would exhibit a performance that is lower than its potential performance if it did not have sorbed components and the performance would decline further if the membrane was contacted with a gas mixture that also comprised water and heavier hydrocarbons. It is preferred, and more economical, to regenerate the membrane after installation, otherwise performance will be compromised and the overall separation process will be less efficient.

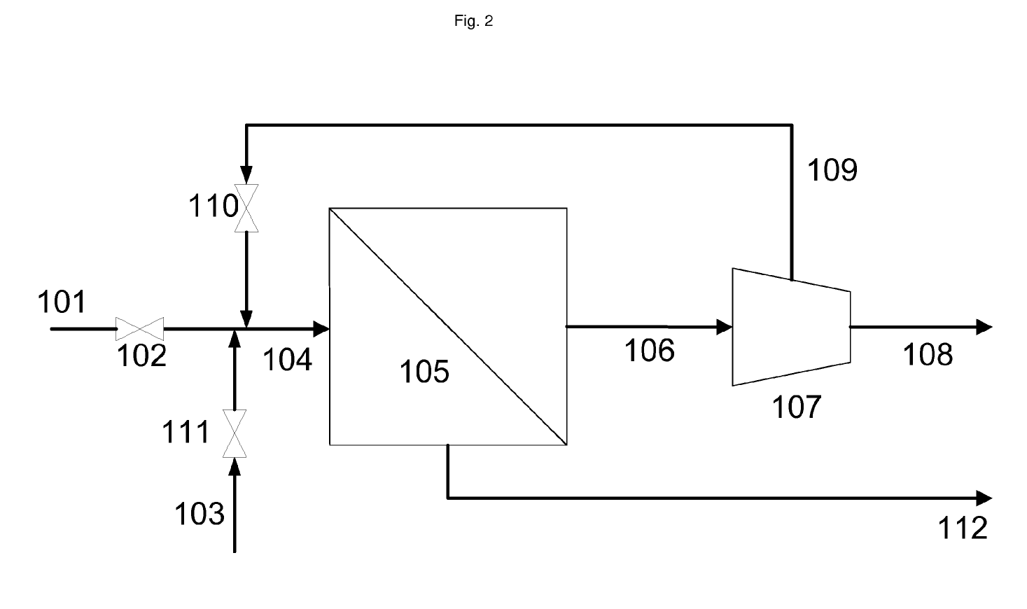

### FIG. 2:

The process will be further described in relation to FIG. 2. The typical feed gas stream for the gas separation process is stream 101. In one embodiment, stream 101 is not placed online but instead stream 103 is fed to the feed side of the membrane. It is preferred that this stream contains carbon dioxide at a concentration of at least 50%, more preferably at least 70% and most preferably at least 90%. The temperature of the stream can be any of those mentioned previously. Carbon dioxide can pass through the pores of the SAPO-34 membrane and also absorbs strongly to the SAPO-34 surface and therefore can aid in the removal of other impurities. The retentate stream 112 and the permeate stream 106 can be further processed downstream or used for other processes.

In typical operation, water, hydrocarbons, or other components may be fed to the membrane as part of stream 101. These components lower the performance of the membrane by adsorbing on the surface of the membrane and blocking the flow of the desired gas components. In one embodiment, the membrane can be regenerated as described previously for the initial startup of the process. In a preferred embodiment, the membrane can be regenerated by recycling a portion of the permeate gas 106 back to the membrane after recompression in a compressor 107. The compressed permeate stream may be heated from the compression process. Compressor 107 does not need to be a single compressor but may be a series of compression stages. The regeneration stream can be taken as an intermediate stream for a series of compression steps. FIG. 2 shows one embodiment, but one of ordinary skill in the art could modify this embodiment.

In a more preferred embodiment, the pressure of stream 109 is slightly greater than stream 101 and the flow of feed stream 101 is not stopped during regeneration but streams 109 and 101 are combined to form stream 104. This allows for regeneration without the loss of production.

In one embodiment, when the gas component used to regenerate the membrane has flowed through the membrane for a sufficient amount of time to restore the performance of the membrane, the flow of that gas component is stopped and the feed of the gas mixture is restarted or allowed to continue.

There are many other modifications that can be employed in a commercial implementation of this method. For example, if multiple tubes or multiple bundles of tubes are used, then some tubes or bundles could be regenerated while the other tubes or bundles are being used for separation of the gas mixture.

Other dry streams such as nitrogen may be also used, but carbon dioxide is preferred because it has a high sorption affinity for SAPO-34 and it can readily permeate the SAPO-34 pores. Nitrogen does not have a very high sorption affinity and does not compete for sorption sites with water. Using air or nitrogen is not as effective and requires the use of higher temperatures to remove the water and heavier hydrocarbons. In addition, the use of these components (especially air) often requires advanced metallurgy, increases the cost of the membrane process, and can increase safety concerns. Any molecule larger than the pores, such as methane, is not as effective for removing unwanted components that have absorbed on the SAPO-34 membrane.

In another embodiment, the carbon dioxide is heated before being used as the third gas component. This lowers the sorption affinity for carbon dioxide, but it has a greater impact on the water sorption due to the high water sorption activation energy.

1. A method of separating a first gas component from a feed gas mixture comprising the first gas component and a second gas component, which method comprises:
a) providing a metalloaluminophosphate molecular sieve membrane having a feed side with a feed inlet and a retentate outlet; and a permeate side with a permeate outlet, wherein the membrane is selectively permeable to the first gas component over the second gas component;
b) introducing the feed gas mixture to the feed inlet;
c) yielding a permeate stream from the permeate outlet and a retentate stream from the retentate outlet wherein the retentate stream is depleted of the first gas component and the permeate stream is rich in the first gas component; and
d) periodically removing unwanted components that are absorbed on the membrane by passing a regeneration gas stream comprising a third gas component through the membrane by feeding the regeneration gas stream to the membrane, and then stopping the regeneration gas stream.

2. A method as claimed in claim 1 wherein the first gas component comprises carbon dioxide.

3. A method as claimed in claim 1 wherein the metalloaluminophosphate molecular sieve is SAPO-34.

4. A method as claimed claim 1 wherein the second gas component comprises a hydrocarbon selected from the group consisting of methane, ethane, propane, butane, isomers thereof, trace amounts of paraffin with carbon number less than 12, and mixtures thereof.

5. A method as claimed in claim 1 wherein the third gas component is the same as the first gas component.

6. A method as claimed in claim 1, wherein the regeneration gas stream is the permeate stream produced in step (c).

7. A method as claimed in claim 1 wherein the unwanted components comprise water.

8. A method as claimed in claim 1 wherein the unwanted components comprise hydrocarbons having a carbon number greater than 3.

9. A method of starting up a process for separating a first gas component from a feed gas mixture comprising the first gas component and a second gas component, which method comprises
a) providing a SAPO-34 molecular sieve membrane having a feed side with a feed inlet and a retentate outlet; and a permeate side with a permeate outlet, wherein the membrane is selectively permeable to the first gas component over the second gas component;
b) passing a startup gas stream comprising a third gas component through the membrane to remove unwanted components;
c) stopping the flow of the startup gas stream;
d) introducing the feed gas mixture to the feed inlet;
e) yielding a permeate stream from the permeate outlet and a retentate stream from the retentate outlet wherein the retentate stream is depleted of the first gas component and the permeate stream is rich in the first gas component.

10. A method as claimed in claim 9 wherein the third gas component is carbon dioxide.

11. A method as claimed in claim 9 wherein the third gas component contains carbon dioxide with a concentration of at least 50%.

12. A method as claimed in claim 9 wherein step (b) is carried out for a time period sufficient to remove at least 75% of the water present in the membrane.

13. A method as claimed in claim 9 wherein step (b) is carried out for a time period sufficient to remove at least 90% of the water present in the membrane

14. A method as claimed in claim 9 wherein the unwanted components are components selected from the group consisting of water and hydrocarbons with carbon number greater than 3.

15. A method of removing water from a SAPO-34 membrane comprising passing carbon dioxide through the membrane at a pressure in the range of from 4 to 100 bar and at a temperature in the range of from 25 to 150° C.
